(19) United States
(12) Patent Application Publication
(10) Pub. No.: US 2026/0208755 A1
(43) Pub. Date: Jul. 23, 2026

(54) LANE CHANGE DECISION-MAKING FOR SAFE LANE CHANGE

(71) Applicants: Cristin Calin PAUN, Portland, OR (US); Lowell S. Brown, Portland, OR (US); Thomas Korsness, Portland, OR (US); Mithil Dharmadhikari, Bangalore (IN); Mrudula Suresh, Bangalore (IN); Nikhil Nair, Bangalore (IN); Gangadhar Malagi, Bangalore (IN)

(72) Inventors: Cristin Calin PAUN, Portland, OR (US); Lowell S. Brown, Portland, OR (US); Thomas Korsness, Portland, OR (US); Mithil Dharmadhikari, Bangalore (IN); Mrudula Suresh, Bangalore (IN); Nikhil Nair, Bangalore (IN); Gangadhar Malagi, Bangalore (IN)

(21) Appl. No.: 19/430,969

(22) Filed: Dec. 23, 2025

(30) Foreign Application Priority Data
Dec. 23, 2024 (IN) 202411101917

(51) Int. Cl. B60W 50/14; B60W 30/18

(52) U.S. Cl. CPC B60W 50/14; B60W 30/18163; B60W 2420/403; B60W 2420/408; B60W 2520/10; B60W 2530/201; B60W 2552/53; B60W 2554/80; B60W 2556/45

(57) ABSTRACT

Provided is a method for a vehicle on a roadway changing from a travel lane to a target lane. The method includes defining, via a computer controller a memory storing instructions related to a plurality of zones of interest relevant to the vehicle changing lanes, each of the travel and target lanes including at least one of the plurality of zones and sensing, via sensors coupled to the vehicle, each of the zones to detect one or more objects therein relevant to the vehicle changing lanes. The sensing occurs dynamically based on one or more of the trajectories of each of the relevant objects. The method also includes continuously determining an extended lane change risk index (ELCRI) for contact between the vehicle and the closest one of the relevant objects while the vehicle changes lanes.

### CROSS REFERENCE TO RELATED APPLICATION

This application claims priority to Indian Application No. 202411101917, filed Dec. 23, 2024, the contents of which are incorporated herein in their entirety.

### FIELD OF THE DISCLOSURE

The present disclosure relates to a vehicle driving system. More particularly, for example, the present disclosure may relate to a vehicle lane change assistance system.

### BACKGROUND

According to statistics, on average, there is a lane change every 12 kilometers (km) on the highway. With this frequency of lane changes in the U.S. alone, there are approximately 530,000 lane change vehicle incidents every year, which constitute about 10% of the country's roadway accidents.

During a lane change attempt, a driver must always be attentive and aware of their surrounding traffic. The attentiveness required, along with other factors such as heavy rain, fog, and general workload, may lead to driver fatigue and impaired judgment.

### SUMMARY

Conventional lane departure warning assistance systems provide a warning to alert a driver when the vehicle unintentionally drifts out of its lane without signaling. As a lane change occurs, there is a need for more sophisticated monitoring and notification systems, for example, to provide updated information during a lane change as conditions change. This is especially the case with larger vehicles such as buses and tractor-trailer trucks, which have larger blind spots and more complex lane changing scenarios when maneuvering lane changes over a larger distance and span of time. For example, there is a need for more extensive and updated lane change information over a prolonged period during which a lane change can occur, while conditions may dynamically change. Some of those changes may include nearby objects changing in type, number, position, direction, or speed.

Given the deficiencies, more comprehensive methods and systems are needed to assist drivers, especially drivers of larger vehicles such as trucks and buses, to make safe lane changes. Additionally, systems are needed to assist drivers of larger vehicles to make safe lane changes dynamically in view of the kinematics of the trajectory of the vehicle in response to the probability and severity of a potential incident with other relevant traveling objects.

To resolve the issues of conventional systems, the present disclosure provides a vehicle lane change assistance system configured to perform lane change assistance based on dynamic risk change calculations.

In the present disclosure, systems are provided to help decide if a lane change is safe or unsafe based on a probabilistic risk calculation using the trajectories of all the relevant vehicles surrounding a vehicle of interest in real time. These systems can also assist in aborting a lane change decision in case of an increase in risk during a lane change maneuver. The system continuously calculates the risk while the vehicle changes lanes.

Under certain circumstances, an embodiment of the present disclosure provides a method for a vehicle on a roadway changing from a travel lane to a target lane. The method includes defining, via a computer controller a memory storing instructions related to a plurality of zones of interest relevant to the vehicle changing lanes, each of the travel and target lanes including at least one of the plurality of zones and sensing, via sensors coupled to the vehicle, each of the zones to detect one or more objects therein relevant to the vehicle changing lanes. The sensing occurs dynamically based on one or more of a trajectory of each of the relevant objects relative to (i) the speed of the vehicle, (ii) dimensions of the vehicle, and (iii) a distance of each of the relevant objects from the vehicle. The method also includes continuously determining an extended lane change risk index (ELCRI) for an incident (e.g., inadvertent contact) between the vehicle and the closest one of the relevant objects while the vehicle changes lanes and providing a safe lane change notification to the controller if the ELCRI is less than a preset threshold.

Another embodiment provides embodiment of the present disclosure relates to a method for a vehicle on a roadway changing from a travel lane to a target lane. The method comprises defining, via a computer controller, a memory storing lane change assessment instructions, determining relevant objects; determining for a given relevant object at a location of the relevant object; determining and updating over a time period a lane change risk indicator for an incident between the vehicle and the given object; and providing to the driver lane change information based on the lane change risk indicator.

In one or more embodiments of the present disclosure, in comparison to conventional systems, the decision to change lane does not consider an instantaneous risk value directly compared with a threshold, but rather an average over a period of time (calculation time for the system) is considered. This consideration may account for uncertainties such as sensor errors, sudden maneuvers, and facilitate smoother braking and driver comfort during a lane change.

The risk index calculation is a continuous calculation even after the lane change maneuver has started. This enables the system to dynamically calculate the risk while the vehicle changes lanes. This feature allows for a rapid lane change abort should the conditions change and the lane change become unsafe. This feature provides further accuracy and flexibility to perform the lane change.

In contrast to conventional systems that consider a combined risk index of all the relevant objects, other embodiments in the present disclosure provide a customized threshold for each detected relevant object. For example, a risk threshold for a rear vehicle can be set higher than the risk threshold for a forward vehicle, considering factors like traffic, historical data, road conditions, and the vehicle's path.

Additional features, modes of operation, advantages, and other aspects of various embodiments are described below with reference to the accompanying drawings. It is noted that the present disclosure is not limited to the specific example embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

So that the way the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an exemplary lane change incident scenario in which embodiments of the present disclosure may be deployed.

FIG. 2 illustrates exemplary vehicle sensors constructed and arranged in accordance with embodiments of the present disclosure.

FIG. 3 illustrates a scenario depicting a vehicle traveling along the roadway in proximity to relevant objects, in greater detail

FIG. 4 illustrates a flow diagram of how various calculations are used and combined to form the extended lane change risk index (ELCRI), in accordance with the embodiments.

FIG. 5 illustrates the introduction of exemplary predetermined time gaps into margins and risk calculation as an additional measure of safety

FIG. 6 illustrates an exemplary lane change decision-making flow using ELCRI in accordance with embodiments.

FIG. 7 illustrates an exemplary flow process for determining a relative stopping distance index (SDI), in accordance with the embodiments.

FIG. 8 illustrates an exemplary computing system upon which lane change decision-making features may be implemented, in accordance with the embodiments.

### DETAILED DESCRIPTION

In the following, reference is made to example embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure.

Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim.

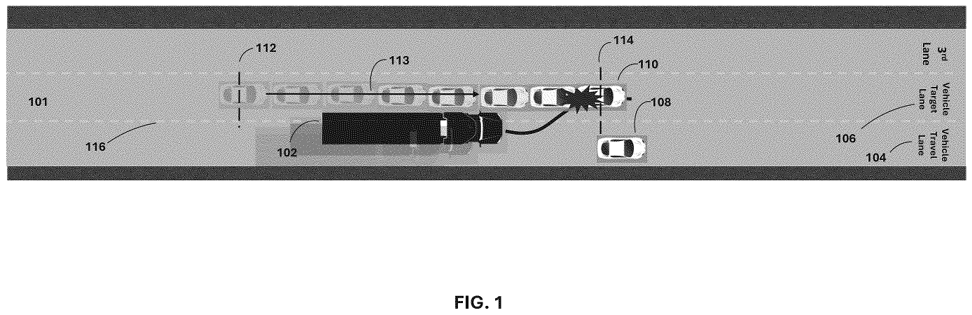

FIG. 1 illustrates an exemplary lane change incident scenario 100 in which embodiments of the present disclosure may be deployed. In the incident scenario 100, a vehicle 102, such as a truck operated by a driver, is traveling along roadway 101 and must change from a vehicle travel lane 104 into an adjacent vehicle target lane 106, on a left side of the vehicle 102. An object 108 (e.g., a car) occupies a position in the vehicle travel lane 104 in front of the vehicle 102.

As the vehicle 102 begins maneuvering left, another object 110 (e.g., another car) moving at a higher rate of speed than the vehicle 102 travels in the adjacent vehicle target lane 106. The object 110, which is initially detected at a location 112, behind and adjacent to the vehicle 102, is traveling along a trajectory 113. Because of its higher rate of speed, the object 110 quickly overtakes the vehicle 102 and moves to a second location 114, in front of (and adjacent to) the vehicle 102. Given the speed of the object 110 relative to the vehicle 102, the driver may have misjudged the trajectory 113 or the location 114 of the object 110 due to fatigue or negligence. As the vehicle 102 attempts to perform a lane change and, in so doing, crosses lane marker 116, it collides with the object 110 as it enters the adjacent vehicle target lane 106.

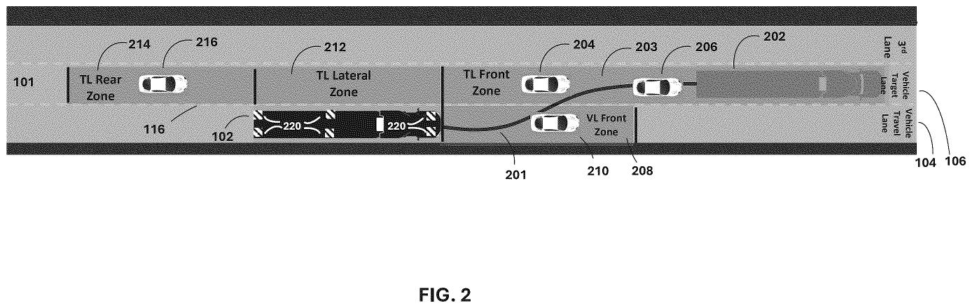

To provide a more detailed approach to assist the lane change decision-making process, embodiments of the present disclosure may divide highway areas of interest, proximate to the vehicle 102, into different zones, as depicted in FIG. 2.

FIG. 2 illustrates an example solution 200 of dividing the highway travel areas of interest into the different zones. In FIG. 2, the vehicle 102 is attempting to make a lane change from the vehicle travel lane 104 to the vehicle target lane 106 along a path 201 to a location 202. The location 202 represents a predicted position (T_{LC}) of the vehicle 102 within the vehicle target lane 106 as the vehicle 102 travels after time (t=TLc). More specifically, the example solution 200 includes the creation of areas of interest for identification of objects that have a probability of colliding with the vehicle 102 during a lane change from the vehicle travel lane 104 to the vehicle target lane 106. In the embodiments, all the zones may be dynamically calculated based on kinematics of the trajectory of a vehicle, such as the vehicle 102. As an example, rear zone may be calculated using ideal field of view (FOV) of sensors 220 coupled to the vehicle 102, discussed in greater detail below.

In the example of FIG. 2, four zones are created with reference to the truck 102 traveling along the roadway 101. Each zone represents an area in which an object may be located that is capable of colliding with the vehicle during a lane change. In the embodiments, an object could be another vehicle, such as a car, motorcycle, etc. Objects must satisfy some preconditions, such as object classification, to be valid for relevant object selection. For example, the object must be classified as a vehicle. The object also needs to be confirmed as valid by the sensors for a minimum duration of time (this duration is parameterizable). The last confirmed time of object detected by the sensor has to be within a parameterizable threshold.

An example solution 200 includes a first zone defined as a target lane (TL) front zone 203. The TL front zone 203 defines an area to be occupied by the vehicle 102 in the future based on its lane change trajectory. The TL front zone 203 may contain one or more objects capable of colliding with the vehicle 102 as it changes from the travel lane 104 to the target lane 106.

Of the multiple objects within the TL front zone 203, the longitudinally closest object in the TL front zone 202 that is closest to the vehicle will be considered the TL front zone 202 relevant object for purposes of vehicle incident probability determinations. For example, the TL front zone 203 of FIG. 2 includes objects (e.g., cars) 204 and 206. However, the object 204 is closest in distance from the vehicle 102. Therefore, the object 204 is considered to be the TL front zone 203 relevant object.

Similarly, the example solution 200 of FIG. 2 includes a second zone defined as a vehicle lane (VL) front zone 208. The VL front zone 208 defines an area in front (inside the travel lane 104) of the vehicle 102 during the lane change. Of potential objects within the VL front zone 208 during the lane change, the object longitudinally closest to the vehicle 102 will be considered the VL front zone 208 relevant object. In the example of FIG. 2, a car 210 is considered to be the relevant object within the VL front zone 208.

A third zone, in the example solution of FIG. 2, is defined as TL lateral zone 212 and is adjacent to the vehicle 102. In the embodiments, the TL lateral zone 212 must be free before the vehicle 202 can attempt any lane change. In other words, the TL lateral zone 212 should always be a free space.

A fourth zone is defined as TL rear zone 214. The TL rear zone 214 includes an area in the target lane 106, behind the vehicle 102. The longitudinally closest object within the TL rear zone 214 will be considered the TL rear zone 214 relevant object. In the example of FIG. 2, the TL rear zone 214, the relevant object 216 is also a car.

Additionally, the vehicle 102 is equipped with one or more sensors 220 for providing a perception of environmental elements surrounding the vehicle 102. For example, the sensors 220 enable the recognition of lane markers, such as the lane marker 116, and relevant objects 204, 206, 216, among other things. By way of example only and not limitation, the sensors 220 can include one or more cameras, short-range sensors (SRS), long-range radar, Lidar sensors, ultrasound sensors, and/or vehicle-to-everything (V2X) technology-based sensors.

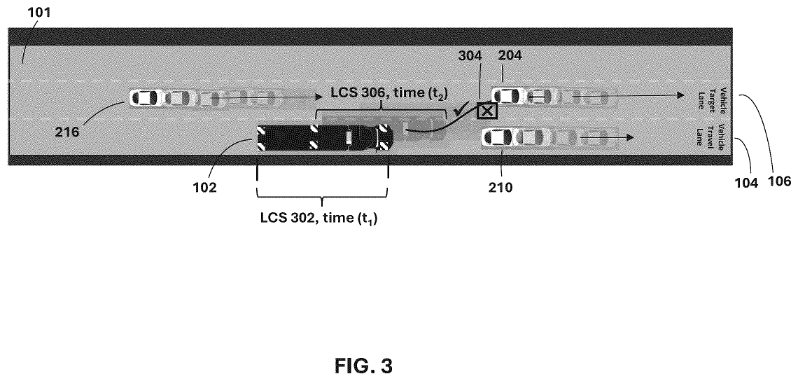

FIG. 3 illustrates a scenario 300 depicting the vehicle 102 traveling along the roadway 101 in proximity to relevant objects, in greater detail. In particular, the vehicle 102 is shown in proximity of TL front zone 203 relevant object 204, VL front zone 208 relevant object 210, and the TL rear zone 214 relevant object 216. As noted above, relevant objects represent the one object in each of the TL front zone 203, the VL front zone 208, the TL lateral zone 212, and the TL rear zone 214 zone that presents the greatest lane change incident risk to the vehicle 102. The trajectories of each of the relevant objects, along with the trajectory of the vehicle, are tracked.

Environmental conditions are also considered. For example, adjustments can be made to account for snow and rain. Other conditions, for example, vehicle parameters, are considered, such as whether the vehicle 102 is a larger vehicle, such as a bus or truck.

Factors such as the frictional coefficients of roads are considered, which account for wet roads/type of concrete, cement roads, etc. The braking distance and reaction time change based on the type of vehicle, such as a car/truck. For example, a truck driver will have a faster reaction time (better line of sight) but a larger braking distance due to higher momentum. The speed and trajectory of the objects are combined and determined relative to the vehicle.

In the embodiments, risk calculations are performed dynamically at predetermined time intervals when each of the relevant objects is detected in a respective one of the zones. By way of example, the risk calculations enable the driver of the vehicle 102 to avoid an unsafe lane change scenario (LCS) 302 at a time (t₁) that results in an incident 304 with the relevant object 204. Instead, the risk calculations enable the driver of the vehicle 102 to perform LCS 306 at a time (t₂), which permits a safe lane change by avoiding contact with the relevant objects 204 and 216.

In the exemplary scenario 300 of FIG. 3, interdependent risk calculations are performed near dynamically and in real time on each of the TL front zone 203 relevant object 204, VL front zone 208 relevant object 210, and the TL rear zone 214 relevant object 216. Ultimately, the objective is to determine an ELCRI. The ELCRI is a function of many factors and represents an indication of whether it is safe to make a lane change or not. The ELCRI is also a function of a series of interdependent, smaller calculations performed in relative terms. That is, all of the risk calculations are performed from a point of view of the vehicle 102, and in relative terms.

These interdependent, and smaller, risk calculations may include, but are not limited to:
(a) Relative Stopping Sight Distance (SSD) or Parking Distance: Sum of the distance travelled during the reaction time of the driver and the distance travelled during braking. The relative SSD considers, for example, the breaking distance, the reaction time of the driver, speed of the vehicle, and the relative speed of the relevant objects, such as the VL front zone 208 relevant object 210 (i.e., a car).
(b) Relative Stopping Distance Index (SDI): The relative SDI is an index for determining the rear-end incident risk based on SSD. The relative SDI, which is also a distance factor, is not a final risk index but provides a high level indication (e.g., the essence) of whether a safe lane change is likely to happen or not.
By way of example, an initial determination is made as to whether the relative SDI is less than zero. In this example, an SDI less than zero may indicate that the vehicle 102 may overshoot the VL front zone 208 relevant object 210.
(c) Real Time-Risk Exposure Level (R-REL): Each instance the relative SDI falls below zero, an unsafe lane change duration (ULCD) is determined. The R-REL is a ratio of the ULCD to a total lane change duration (TLCD), which can be expressed as a probabilistic measure with a value between zero and one.
In one example calculation, and assumption for a total lane change duration may be, for example, (8) seconds for changing from the vehicle travel lane 104 to the vehicle target lane 106. Out of the total (8) seconds, a risk of an incident exists for (6) seconds. That is, the ULCD is (6) seconds.
Next, a ratio that compares the ULCD to the TLCD can be taken to determine the R-REL, or exposure level. In this example, the R-REL is a measure of the probability of an incident occurring (6) out of the (8) seconds. This measure is completely relative because it is a function of a relative object in front of the vehicle 102 (e.g., the object 210) in addition to the speed of the relative object.
(d) Real Time-Risk Severity Level (R-RSL): The R-RSL ratio was developed to reflect a situation where a relatively higher speed leads to an increase in the severity of a vehicle incident. For example, the severity of an incident that occurred at 100 kilometers/hour (km/h) would be different than the severity of an incident that occurred at 20 km/h. Because the R-RSL and R-REL, which represent worst case scenarios, could change at every instance of time, the R-RSL and R-REL are calculated dynamically and in real time.
(e) Extended lane change risk index (ELCRI): The ELCRI represents the failure of safe vehicle interaction between a subject vehicle and the surrounding vehicles. The ELCRI is a function of R-RSL and R-REL. For example, R-REL represents the potential of the risk, or exposure level and R-RSL represents the severity of an incident, if it occurs.
The two R-RSL and R-REL ratios are combined to produce the ELCRI, or the final risk index. Different ELCRI calculations are performed on each of the relative objects 204, 210, and 216. Performing different, yet continuous, ELCRI calculations separately for each of the relative objects enables dynamically determining separate risk thresholds, respectively. That is, each of the relevant objects may have a different risk threshold.
(f) System Failure: System failure is the probability of failure to perform a safe lane change if the ELCRI for any object exceeds the threshold.

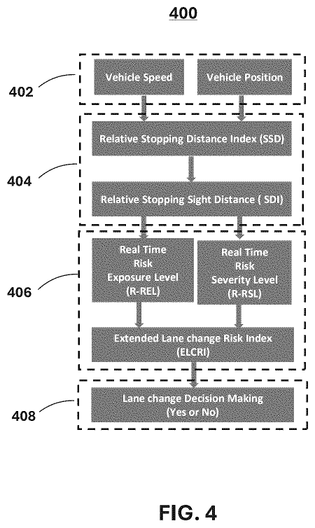

FIG. 4 illustrates a flow diagram 400 of how the interdependent risk calculations (a)-(f) discussed above are used and combined to produce a decision of whether or not to perform a lane change. In a block 402 of FIG. 4, real time data associated with the vehicle 102, such as speed and position, is obtained. In block 404, an extraction of evaluation measurements is performed based on the relative SSD and the relative SDI.

In block 406, calculation of the R-REL exposure level ratio and the R-RSL severity level ratio are performed separately for each relevant object. The two R-REL and R-RSL ratios are combined for each relevant object to produce the separate ELCRI values. If ELCRI is greater than the threshold (discussed in greater detail below) for at least one of the relevant objects, the lane change decision will be a NO.

Another dynamic aspect of the ELCRI calculation is that the ELCRI calculations that occur during different cycles may use data provided by different ones of the relevant objects 204, 206, and 216. The net effect, by way of example, is that as the vehicle 102 travels during one cycle, the relevant object 204 may present the greatest risk to when the vehicle 102 attempts to make a lane change maneuver.

In the exemplary embodiments, (1) cycle time=1 sample time of the processor/algorithm. Therefore, for example, the traffic scenario for the entire duration of lane change (TLc) is calculated every sample time which happens to be 0.02 seconds(s) in one exemplary embodiment. By way of example, the entire flow diagram 400 occurs in one (1) sample time which may be approximately 0.02 s. When considering one (1) second of calculation time, for example, ELCRI (FIG. 4) is calculated 50 times in that single second. This process provides sufficient data to predict if a lane change is possible or not.

However, because of the dynamics of traffic flow, the relevant object 216 may present the greatest risk in the next cycle. As a result, after the vehicle 102 has already started performing a particular lane change maneuver deemed as safe during one time instance, the vehicle 102 may be instructed to abort the maneuver (presently being performed) during the next time instance because the traffic flow dynamics have changed for one or more of the relevant objects 204, 206, and 216.

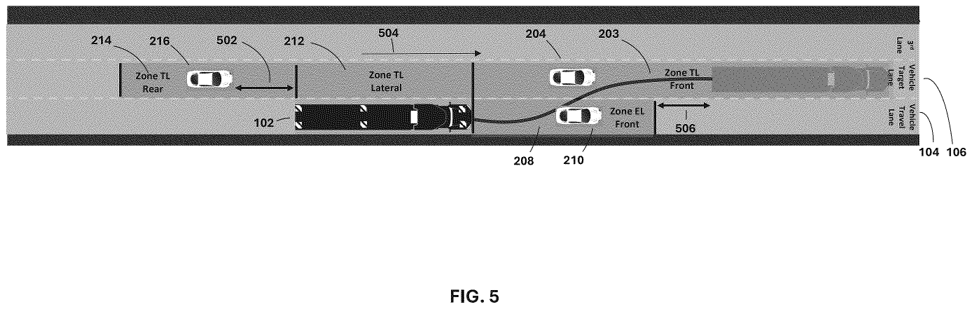

FIG. 5 illustrates the introduction of predetermined time gaps 500 into margins and risk calculation as an additional measure of safety. In the embodiments, in addition to the risk calculations (a)-(f) above, a safety distance gap may be added to each calculation as a buffer. That is, a safety distance gap (e.g., up to several seconds) can be added as a buffer between the vehicle and the relevant object. By way of example only, and not limitation, in some instances a 1-second safety gap may be used.

Stated another way, each of the calculations (a)-(f) may include an additional buffer as part of the calculation itself such that when a lane change maneuver is performed by the vehicle 102, even higher risk maneuvers may be performed more safely because of the multi-second buffer between the vehicle 102 and a relevant object.

Returning to FIG. 5, a safety time gap 502 of about one second may be added between a front section of the relevant object 216 and a rear section of the vehicle 102 to provide a further margin of safety for a lane change. Although a one second gap was used in the illustration of FIG. 5, any suitable range of values may be used and are within the spirit and scope of the present disclosure. A real-time calculation 504 of vehicle trajectory and risk index a relevant object is performed.

The vehicle trajectory and risk index are calculated, for example, at every sample time (0.02 s in this case), which provides an ability to predict the trajectories for the entire TLc by using the updated sensor information. The prediction for the next trajectory happens once every sample time/cycle time (0.02 s). Calculations are based on the information from the sensors which is also received in real time. This then allows the system to dynamically make decisions of whether the lane change can continue or abort.

The safety time gap for objects in the vehicle lane front and the target lane front (such as object 210) is added to front of the vehicle/rear of the front object. In case of the front, an additional safety time gap 506 of about 1 s is added between a front section of the relevant object 210 and a rear section of the vehicle 102. The additional safety gap 506 builds in additional time between the vehicle 102 in the border of the EL front zone 208 that includes the relevant object 210. This safety gap ensures the vehicle 102 has sufficient time to complete the change from the vehicle travel lane 104 to the vehicle target lane 106.

In the embodiments, although the vehicle 102 may initiate the lane change, the lane change risk calculation does not stop at this moment. That is, the lane change risk calculations are performed continuously and each of the relevant objects associated with the vehicle 102 continues to be monitored. In this manner, for example, risk change calculations, such as ELCRI, are more dynamic than conventional early warning system calculations. In the present disclosure, because the risk change calculations continue, even after a lane change maneuver has been initiated, that maneuver can be aborted once the risk case reaches the preset threshold. This ability accommodates a scenario where a lane change is determined to be safe now it is initiated but later becomes unsafe before completion of the lane change maneuver.

Using a more dynamic risk calculation process, such as separately and dynamically calculating risk indices for each of the four relevant objects avoids a combined risk index errors characteristic of conventional systems. For example, many conventional systems combine the risk of all of the relevant objects. If the relevance of one of the objects disappears, because of a fault or because that object simply left the highway for example, the original combined risk index continues to be erroneously multiplied with other risk indices. This results in an inaccurate risk index, at least for a few seconds, that can negatively impact decision-making.

The dynamic risk calculation approach as used herein enables the rapid change in parameterization of the thresholds and provides more accurate risk index calculations for each of the relevant objects. Ultimately, a more accurate and reliable lane change decision-making process is provided.

Risk calculations that are performed as described herein are a function of calculated trajectories of the vehicle 102 and separately, a function of trajectories of the relevant objects 204, 210, and 216. Because trajectories also rely in part on sensor data, accuracy of the trajectories is dependent upon the accuracy of the sensors 220 and accordingly, may include some uncertainty. For example, any uncertainty in the sensors 220 or sudden maneuvers of the vehicle 102 or any of the relevant objects 204, 210, and 216 can create significant changes in the data and/or results from one cycle to the next.

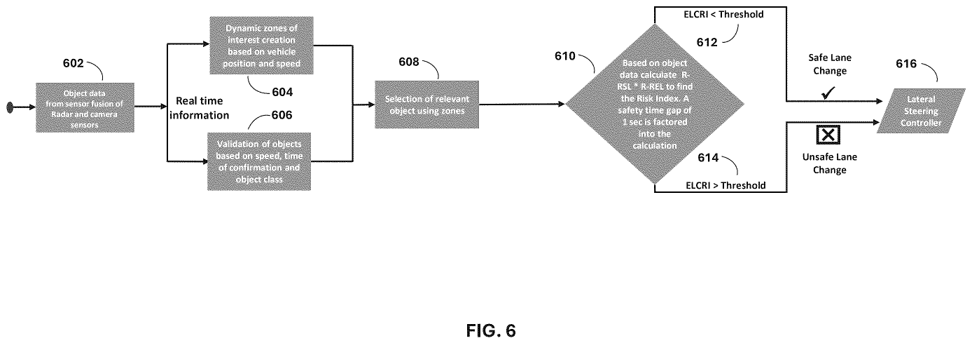

To reduce the impact of these uncertainties, one or more embodiments of the present disclosure may perform a moving average of the risks determination, discussed in greater detail below. In applying moving average determinations, a lane change decision is made only after a certain period of time. In other words, the lane change decision is made after moving average reaches the threshold. Such an approach is not instantaneous but rather results from an average over time. Some of these features are addressed more fully below in the discussion of FIG. 6.

FIG. 6 illustrates an exemplary lane change decision making flow 600 using ELCRI determination in accordance with the embodiments. In block 602 of the decision making flow 600, data (e.g., position, speed, trajectory etc.) is received via the sensors 220 to produce real time information associated with objects surrounding the vehicle 102. As described above, example objects include the relevant objects 204, 210, and 216. In block 604, the real time information is used to determine zones of interest based on the position and speed of the vehicle 102.

In block 606, presence of the objects is validated based on the speed, time of confirmation, and a class (e.g., bus, car, motorcycle etc.) of the identified objects. Based on the identified zones (block 604) of interest and the validated objects (block 606), relevant objects, in association with the vehicle 102 are identified in block 608. For a more detailed explanation of the zones of interest, please see the discussion above associated with the description of FIG. 2. The relevant objects and zones of interest in block 608 are provided to block 610 for calculation of the ELCRI, as discussed above. The ELCRI is calculated with an example moving average of one second that is provided as a safety gap, or an additional measure of safety.

A first ELCRI calculation step (step-1) calculates a relative SSD. The relative SSD is the distance travelled by vehicle during reaction/perception time of driver+the braking distance. The SSD is calculated using the speed of the vehicle 102, relative speed of the objects from sensor fusion/various sensors 220, reaction time of the driver, and coefficient of friction. In the embodiments described herein, the SSD may be a function of several factors including relative speed of the object (RelSpd), speed of the vehicle 102 (EgoSpd), reaction time of the driver (tr), and coefficient of friction (mu). One exemplary expression defining a relationship between these factors is shown in equation (a) below:

$$SSD = ( ( RelSpd + 2 * EgoSpd ) * RelSpd ) / ( 254 * μ ) + ( RelSpd * 0.278 * {t}_{r} ) \qquad ( a )$$

In a second ELCRI calculation step (step-2), a relative distance (dxgap) to the object at every cycle is predicted using a constant acceleration model. The relative distance is calculated using relative speed, relative acceleration and initial distance of the object measured from sensor at t=0. The relative distance to the object is calculated as a function of several factors including relative acceleration of the object (RelAccel), range from 0 to total time to lane change (t), longitudinal distance to the object from senso (rdxObj). One exemplary expression defining a relationship between these factors is shown in equation (b) below:

$${d}_{x} gap = RelSpd * t + \frac{1}{2} * RelAccel * {t}^{2} + {d}_{x} Obj \qquad ( b )$$

A third ELCRI calculation step (step-3) determines safety gap (dxSafety). The safety gap is the minimum longitudinal distance a vehicle has to always maintain with the other road users. It is computed using the current velocity of the vehicle and the desired time gap between the vehicles. The safety gap is a function of various factors, including speed of the ego truck (EgoSpd), and safety time gap (tg). One exemplary expression defining a relationship between these factors is shown in equation (c) below:

$${d}_{x} Safety = EgoSpd * {t}_{g} \qquad ( c )$$

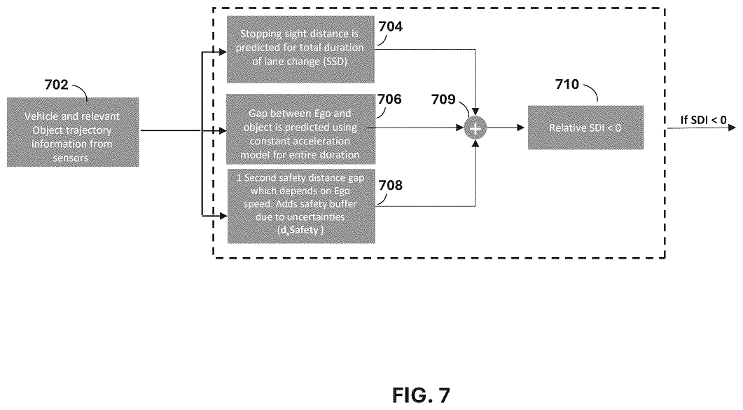

FIG. 7 illustrates an exemplary flow process 700 for determining the SDI, in accordance with the embodiments. In the flow process 700, the SDI calculation begins with block 702 with detection of trajectory information for the relevant objects 204, 210, and 216 and trajectory information for the vehicle 102. As noted earlier, this information, which is calculated separately for each of the relevant objects, is updated every cycle. The trajectories calculated in block 702 are provided as input to blocks 704, 706, and 708 for further ELCRI calculations.

In block 704, the SSD, calculated in step-1 of the ELCRI calculation, is predicted for total duration of lane change based on the trajectories calculated in block 702. In block 706, a gap between the vehicle 102 and the relevant object is predicted using a constant acceleration model for entire duration lane change (dxgap). In block 708, a one second safety distance gap, which depends on the speed of the vehicle 102, is added as a safety buffer due to uncertainties (dxSafety) based on the trajectories calculated in block 702.

Outputs from blocks 704, 706, and 708 are combined in block 709 and provided as an input to block 710. Block 710 implements a fourth step (step-4) of the ELCRI calculation. More specifically, block 710 calculates the relative SDI and predicts SDI from t=0 to the total lane change duration.

As noted earlier, the relative SDI is a measure of the remaining distance between the vehicle 102 and the relevant objects 204, 210, and 216 (including other factors such as safety distance) after a braking event by the object 210 positioned in front of the vehicle 102. By way of example, a negative SDI not only indicates a vehicle incident is imminent but also the severity of the incident. The relative SDI is calculated using the SSD from step-1, relative distance calculated in step-2, and the safety gap calculated in the step-3. The relative SDI is a function of various factors including dxgap, the relative SSD, and dxSafety. One exemplary expression defining a relationship between these factors is shown in equation (b) below:

$$SDI = {d}_{x} gap + SSD = {d}_{x} Safety \qquad ( d )$$

The relative SDI depends on the difference between the distance of the vehicle 102 and the relevant objects 204, 210, and 216 as described above. When the difference is negative, the ULCD is calculated. Namely, if the relative SDI is less than zero, a fifth ELCRI calculation step (step-5) is performed. Step-5 calculates the ULCD. The ULCD is a summation of the time duration for which SDI<0. This means the vehicle 102 and the relevant objects 204, 210, and 216 are predicted to be exposed to an incident for that period. Step-5 also calculates the max absolute SDI. The ULCD, calculated in step-5 of the ELCRI calculation, is used in the final steps (step-6, step-7, and step-8) of calculating the ELCRI.

Returning to FIG. 6, the ULCD of step-5 is used to calculate R-REL (step-6) in block 610 of the flow 600. The R-REL gives the likelihood of an incident occurrence. Chances of a lane change incident increase when a vehicle is exposed to a dangerous situation for a relatively long period of time while changing the lane. This is calculated using the ULCD obtained from step-5. An expression for calculation of R-REL is shown in equation (e) below:

$$ELCRI = RREL * RRSL \qquad ( e )$$

The seventh step (step-7) in the ELCRI calculation is R-RSL. The R-RSL is a measure of the severity of the incident (e.g, contact). Relatively higher speeds lead to an increase in the severity of an incident. This is the ratio of the max SDI obtained from Step 5 and SDI critical (max SDI of the vehicle at highest maximum speed). The R-RSL is a function of various factors including absolute maximum SDI (SDIₘₐₓ) and the worst-case scenario SDI wherein the ego speed is at highest limit and object speed is 0 (SDI_{cri}). An expression for calculation of R-REL is shown in equation (f) below:

$$RREL = ULCD / TLCD \qquad ( f )$$

An eighth and final step (step-8) of the ELCRI is performed in block 610 of the flow 600. As discussed above, the ELCRI is a combined total risk for a single object based on its exposure and severity levels. This index is calculated for all relevant objects. If the ELCRI is found to be greater than the threshold (calculated based on data and regulations) then lane change is unsafe at that instance. The ELCRI is calculated as a moving average, for example, over one second after which a decision to change the lane may be made. The ELCRI calculation is then continued over the period of the entire maneuver to decide if the lane change must be aborted or not. An expression for calculation of an ELCRI value is shown in equation (g) below:

$$RRSL = {SDI}_{max}^{abs} / {SDI}_{cri} \qquad ( g )$$

In block 612, if the ELCRI calculation value is less than the threshold, a safe lane change notification is sent to a lateral steering controller in the vehicle 102. On the other hand, in block 614, if the ELCRI calculation value reaches or exceeds the threshold, an unsafe lane change notification is sent to the lateral steering controller in the vehicle 102.

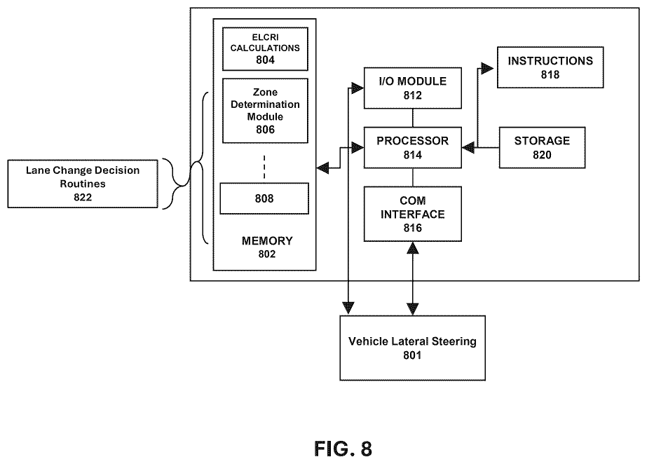

FIG. 8 describes an exemplary computing system 800 configurable to execute the various methods and processes described above. In the computing system 800 (e.g., the flow 600) or steps thereof as described herein may be embodied as instructions that can cause the computing system 800 to perform operations consistent with auto-syncing an application pod to a desired state using a feedback mechanism to monitor observability errors and dynamically fix, redeploy, or change a state of one or more pods in an application pod. For example, the method may be embodied as instructions residing in a non-transitory component such as a memory or a storage device associated with the computing system 800. That is, the structure of the computing system 800 is imparted by the methods described herein in the form of instructions.

The computing system 800 may be an application-specific hardware, software, and firmware implementation (or a combination thereof) configured to execute the exemplary methods described herein. The system 800 may also represent a structural and application-specific implementation of the other exemplary systems described herein configured for performing lance change assistance. The computing system 800 can include a processor 814 configured to execute one or more, or all of the blocks of the exemplary methods described previously.

The processor 814 can have a specific structure imparted thereto by instructions 818 stored in a memory 802 and/or by instructions 818 fetchable by the processor 814 from a storage medium 820. The storage medium 820 may be co-located with the computing system 800 as shown, or it can be remote and communicatively coupled to the computing system 800. Such communications may be encrypted.

The computing system 800 may be a stand-alone programmable system, or a programmable module included in a larger system. For example, the computing system 800 can be included as part of a cloud environment or as a part of computing system 800 configured to monitor and reconfigure a cloud environment. Also, the computing system 800 may include one or more hardware and/or software components configured to calculate lane change risk calculations.

The processor 814 may include one or more processing devices or cores (not shown). In some embodiments, the processor 814 may be a plurality of processors, each having one or more cores. The processor 814 can execute instructions fetched from memory 802, i.e., from one of memory modules 804, 806, or 808. By way of example only, and not limitation, the memory module 804 may store instructions that represent the ELCRI calculations block 610 of FIG. 6, the memory module 806 may store instructions that represent the vehicle zone selection block 608.

Alternatively, the instructions can be fetched from the storage medium 820 or from a remote device connected to the computing system 800 via a communication interface 816. An input/output (I/O) module 812 may be configured for additional communications to or from remote systems or to a user interface 803 from which the processor 814 may receive a set of requirements. Such additional communications may be facilitated by a communications interface 816.

Without loss of generality, the storage medium 820 and/or the memory 802 can include a volatile or non-volatile, magnetic, semiconductor, tape, optical, removable, non-removable, read-only, random-access, or any type of non-transitory computer-readable computer medium. The storage medium 820 and/or the memory 802 may include programs and/or other information usable by processor 814, such as, for example, instructions that enable the processor 814 to perform auto-syncing operations for an application pod in a cloud environment. Furthermore, the storage medium 820 can be configured to log data processed, recorded, or collected during the operation of the system 800.

The data may be time-stamped, location-stamped, cataloged, indexed, encrypted, and/or organized in a variety of ways consistent with data storage practice. By way of example, the memory modules 804 to 810 can form instructions that embody the method 300. In other words, the memory modules 804 to 810 may form a set of automated self-healing routines 822 that can cause the processor 814 to perform certain operations upon execution to auto-sync an application pod of a Kubernetes environment 801 that is communicatively coupled to the system 800.

The embodiments provide advanced methods and systems for determining the safety of lane changes based on a probabilistic risk calculation using real-time trajectories of all relevant objects surrounding the vehicle. That is, the embodiments provide judgments based on relevant objects. As a result, the embodiments provide a safer lane change maneuver user experience.

Exemplary aspects of the embodiments include:
a) Incorporation of Safety Gaps: The embodiments include a safety time gap (parametrizable) in their calculations, adding an extra buffer to account for uncertainties. This safety gap ensures that even higher-risk maneuvers can be performed more safely. It also adds a safety margin for smoother braking and may confirm that regulations are satisfied.
b) Dynamic Risk Calculation: Unlike conventional systems that rely on instantaneous risk values, the embodiment calculates ELCRI as a moving average over a period of time (calculation time for the system). This approach accounts for uncertainties such as sensor errors and sudden maneuvers, providing smoother braking and enhanced driver comfort during lane changes.
   The dynamic calculation of risk also provides the ability to abort a lane change already being performed. The dynamic calculation provides further accuracy and flexibility to perform the lane change.
   The conventional system, by contrast, provides early warning systems that do not consider any changes occurring during the maneuver. The conventional system also do not specify relevant objects.
   Probabilistic risk calculation using real-time trajectories of all relevant objects surrounding the vehicle.
c) Continuous Monitoring and Calculation: The risk index calculation continues even after the lane change maneuver has started. This allows the system to dynamically update the risk assessment and potentially abort the lane change if conditions become unsafe.
   Continuous monitoring provides greater accuracy and flexibility compared to conventional early warning systems that stop calculations once the lane change maneuver begins.
d) Customized Risk Thresholds: The embodiments introduce the concept of customized risk thresholds for each relevant object. For example, the risk threshold for a rear vehicle can be set higher than that for a forward vehicle, considering factors like traffic conditions, historical data, road conditions, and the ego vehicle's path. This tailored approach enhances the accuracy of risk assessments.
e) Real-Time Object Validation: The system dynamically validates objects based on their speed, time of confirmation, and classification (e.g., car, truck, motorcycle). This ensures that only relevant objects are considered in the risk calculations, improving the reliability of the system.
f) Abort Lane Change Feature: The system can suggest aborting a lane change if the risk index exceeds a preset threshold during the maneuver. This feature provides an additional layer of safety by allowing the vehicle to return to its travel lane if conditions become unsafe.

These exemplary features collectively provide a more comprehensive, accurate, and dynamic approach to lane change decision-making, significantly enhancing the safety and reliability of lane change maneuvers for larger vehicles such as trucks and buses.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed, rather the invention extends to all functionally equivalent structures, methods, and uses such as are within the scope of the appended claims.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded with the broadest scope consistent with the principles and novel features disclosed herein.

While the foregoing is directed to embodiments of the present disclosure, other and further embodiments of the disclosure may be devised without departing from the basic scope thereof, and the scope thereof is determined by the claims that follow.

We claim:

1. A method for a vehicle on a roadway changing from a travel lane to a target lane, the method comprising:
defining, via a computer controller, a memory storing instructions related to a plurality of zones of interest relevant to the vehicle changing lanes, each of the travel and target lanes including at least one of the plurality of zones;
sensing, via sensors coupled to the vehicle, each of the zones to detect one or more objects therein relevant to the vehicle changing lanes;
wherein the sensing occurs dynamically based on one or more of a trajectory of each of the relevant objects relative (i) a speed of the vehicle, (ii) dimensions of the vehicle, and (iii) a distance of each of the relevant objects from the vehicle;
continuously determining an extended lane change risk index (ELCRI) for contact between the vehicle and the closest one of the relevant objects while the vehicle changes lanes; and
providing a safe lane change notification to the controller if the ELCRI is less than a preset threshold.

2. The method of claim 1, wherein the ELCRI is continuously determined for each of the relevant objects.

3. The method of claim 1, wherein the travel lane includes a front zone defining an area in front of the vehicle, the target lane includes (i) a front zone located in front of, and adjacent to, the vehicle, (ii) a lateral zone located beside the vehicle, and (iii) a rear zone behind and adjacent to the vehicle.

4. The method of claim 1, wherein the sensors include at least one of a radar, a camera, a short range sensor, lidar, and a vehicle-to-everything (V2X) transceiver.

5. The method of claim 4, wherein at least one of the sensors is configured for providing information about objects near the vehicle, and another sensor is configured for detecting lane markings.

6. The method of claim 1, wherein the sensing includes calculating an amount of time and distance required for the vehicle to move from the travel lane to each of (i) the target lane front zone, (ii) the target lane front zone, (iii) the target lane lateral zone, and (iv) the target lane rear zone as the vehicle travels in the travel lane.

7. The method of claim 6, wherein the sensing occurs once per cycle.

8. The method of claim 1, wherein the ELCRI is a function of one or more of a stopping sight distance (SSD), a stopping distance index (SDI), a real time risk exposure level (R-REL), and a real time risk severity level (R-RSL).

9. The method of claim 8, wherein the continuously determining occurs every cycle time.

10. The method of claim 1, further comprising providing an abort lane change notification if the ELCRI reaches the preset threshold after the safe lane change notification was provided.

11. A non-transitory computer readable medium having stored thereon computer executable instructions that, if executed by a computing device, cause the computing device to perform a method for a vehicle on a roadway changing from a travel lane to a target lane, the method comprising:
defining a plurality of movement zones of interest relevant to the vehicle changing lanes, each of the travel and target lanes including at least one of the plurality of zones sensing, via sensors coupled to the vehicle, each of the zones to detect one or more objects therein relevant the vehicle changing lanes;
wherein the sensing occurs dynamically based on one of more of (i) a trajectory of each of the relevant objects relative to (i) a speed of the vehicle, (ii) dimensions of the vehicle, and (iii) a distance of each of the objects from the vehicle.
continuously determining an extended lane change risk index (ELCRI) for contact between the vehicle and a closest one of relevant objects; and
providing a safe lane change notification to the controller if the ELCRI is less than a preset threshold.

12. The non-transitory computer readable medium of claim 11, wherein the ELCRI is continuously determined for each of the relevant objects.

13. The non-transitory computer readable medium of claim 12, wherein the travel lane includes a front zone defining an area in front of the vehicle, the target lane includes (i) a front zone located in front of, and adjacent to, the vehicle, (ii) a lateral zone located beside the vehicle, and (iii) a rear zone behind and adjacent to the vehicle.

14. The non-transitory computer readable medium of claim 13, wherein at least one of the sensors is configured for providing information about objects near the vehicle, and another sensor is configured for detecting lane markings.

15. The non-transitory computer readable medium of claim 11, wherein the sensing includes calculating an amount of time and distance required for the vehicle to move from the travel lane to each of (i) the target lane front zone, (ii) the target lane front zone, (iii) the target lane lateral zone, and (iv) the target lane rear zone as the vehicle travels in the travel lane.

16. The non-transitory computer readable medium of claim 15, wherein the sensing occurs once per cycle.

17. The non-transitory computer readable medium of claim 11, wherein the ELCRI is a function of one or more of a stopping sight distance (SSD), a stopping distance index (SDI), a real time risk exposure level (R-REL), and a real time risk severity level (R-RSL).

18. The non-transitory computer readable medium of claim 17, wherein the continuously determining occurs every cycle time.

19. The non-transitory computer readable medium of claim 11, further comprising providing an abort lane change notification if the ELCRI reaches the preset threshold after the safe lane change notification was provided.

20. A system for assisting a vehicle in changing lanes on a roadway, comprising:
a plurality of sensors (i) coupled to the vehicle and (ii) configured to detect objects in a travel lane and a target lane of the vehicle; and
a processor configured to:
define a plurality of zones of interest relevant to the vehicle changing from the travel lane to the target lane, each of the travel and target lanes including at least one of the plurality of zones;
dynamically sense each of the zones to detect one or more objects therein relevant to the vehicle changing lanes, wherein the dynamic sensing is based on one or more of a trajectory of each of the relevant objects relative to (i) a speed of the vehicle, (ii) dimensions of the vehicle, and (iii) a distance of each of the relevant objects from the vehicle;
continuously determine an extended lane change risk index (ELCRI) for contact between the vehicle and the closest one of the relevant objects while the vehicle changes lanes; and
provide a safe lane change notification if the ELCRI is less than a preset threshold.
